(19) United States
(12) Patent Application Publication
(10) Pub. No.: US 2024/0186803 A1
(43) Pub. Date: Jun. 6, 2024

(54) SWITCHING ASSEMBLY AND CHARGING METHOD FOR AN ELECTRICAL ENERGY STORAGE SYSTEM

(71) Applicant: Robert Bosch GmbH, Stuttgart (DE)

(72) Inventors: Berengar Krieg, Gerlingen (DE); Ian Patrick Moss, Stuttgart (DE); Jochen Weber, Asperg (DE); Johannes Swoboda, Stuttgart (DE); Josef Goeppert, Kusterdingen (DE); Ngoc Ho Tran, Reutlingen (DE); Philipp Heimbucher; Samuel Vasconcelos Araujo, Esslingen Am Necker (DE)

(21) Appl. No.: 18/552,536

(22) PCT Filed: Mar. 2, 2022
(86) PCT No.: PCT/EP2022/055221

§ 371 Date: Sep. 26, 2023

(30) Foreign Application Priority Data
Apr. 1, 2021 (DE) 10 2021 203 352.0

(51) Int. Cl. H02J 7/00

(52) U.S. Cl. CPC H02J 7/0024; H02J 7/00302; H02J 7/0031; H02J 2310/48

(57) ABSTRACT

A switching assembly for an electrical energy storage system having a first energy storage unit and a second energy storage unit, each having a first pole terminal and a second pole terminal, comprising:
at least a first output and a second output for electrically conductive connection to at least one electrical component,
a first switching unit arranged between the first pole terminal of the first energy storage unit and the first output,
a second switching unit arranged between the second pole terminal of the first energy storage unit and the second output,
a third switching unit arranged between the first pole terminal of the second energy storage unit and the first output,
a fourth switching unit arranged between the second pole terminal of the second energy storage unit and the second output,
a fifth switching unit arranged between the second pole terminal of the first energy storage unit and the first pole terminal of the second energy storage unit,
wherein the first switching unit is connected to the third switching unit,
wherein the second switching unit is connected to the fourth switching unit,
wherein at least the first and the third switching unit and/or the second and the fourth switching unit or the first and the fourth switching unit comprise two semiconductor switching elements arranged so as to be connected to one another in an antiserial manner.

### BACKGROUND OF THE INVENTION

The present invention relates to a switching assembly and a charging method for an electrical energy storage system.

DE 10 2017 206 834 A1 shows a switching assembly and a charging method for an electrical energy storage system.

DE 103 30 834 A1 shows a method and an apparatus for supplying at least one load in the event of a mains failure.

WO 2011/105794 discloses a hybrid cell system having a serial switching circuit, whose secondary cells can be connected serially as well as in parallel.

### SUMMARY OF THE INVENTION

The core of the invention in the switching assembly for an electrical energy storage system having a first energy storage unit and a second energy storage unit, each having a first pole terminal and a second pole terminal consists in that the switching assembly comprises:
at least a first output and a second output for electrically conductive connection to at least one electrical component,
a first switching unit arranged between the first pole terminal of the first energy storage unit and the first output,
a second switching unit arranged between the second pole terminal of the first energy storage unit and the second output,
a third switching unit arranged between the first pole terminal of the second energy storage unit and the first output,
a fourth switching unit arranged between the second pole terminal of the second energy storage unit and the second output,
a fifth switching unit arranged between the second pole terminal of the first energy storage unit and the first pole terminal of the second energy storage unit,
   wherein the first switching unit is connected to the third switching unit,
   wherein the second switching unit is connected to the fourth switching unit,
   wherein at least the first switching unit and the third switching unit and/or the second switching unit and the fourth switching unit or the first switching unit and the fourth switching unit comprise two semiconductor switching elements arranged so as to be connected to one another in an antiserial manner.

The background of the invention is that semiconductor switching elements are more compact and durable than mechanical switches and allow for higher switching dynamics. By means of the antiserially connected arrangement of two semiconductor switching elements, charging currents and decharging currents are independently interruptible. As a result, an electrical energy storage can be further decharged in a critical operating state in order to perform a safety action while the charging currents are interrupted so as to conserve the electrical energy storage.

Advantageously, the energy storage units can be connected to the electrical component in parallel circuitry or in serial circuitry so that the electrical component can be operated at different voltages.

Advantageously, the semiconductor switching elements are configured as transistors, in particular power transistors, for example as MOSFETs or IGBTs.

Further advantageous embodiments of the present invention are the subject matter of the subclaims.

According to an advantageous embodiment, the switching assembly comprises at least a first input and a second input for electrically conductive connection to a voltage source, wherein the first input can be connected to the first switching unit and the third switching unit, in particular by means of a sixth switching unit, wherein the second input can be connected to the second switching unit and the fourth switching unit, in particular by means of a seventh switching unit. As a result, the energy storage units can be connected in parallel circuitry or in serial circuitry with the voltage source so that voltage sources or charging stations with different output voltages can be used in order to charge the energy storage system.

According to a further advantageous embodiment, the first pole terminal of the first electrical energy storage unit can be connected by means of the third switching unit to the first pole terminal of the second electrical energy storage unit, and the second pole terminal of the first electrical energy storage unit can be connected by means of the second switching unit to the second pole terminal of the second electrical energy storage unit. It is advantageous that only the first and fourth switching units need to be opened in order to disconnect the electrical energy storage units from the inputs and the outputs.

It is advantageous in this case when the second switching unit comprises a single semiconductor switching element, which is configured in particular so as to block in the charging direction, and the third switching unit comprises a single semiconductor switching element, which is configured in particular so as to block in the charging direction. The second and third switching units can thus be designed in a compact manner.

Furthermore, it is advantageous when the first switching unit and the fourth switching unit each comprise two semiconductor switching elements arranged so as to be connected to one another in an antiserial manner, wherein a first center tap is arranged between the semiconductor switching elements of the first switching unit, wherein a fourth center tap is arranged between the semiconductor switching elements of the fourth switching unit, wherein the sixth switching unit is connected to the first center tap and the seventh switching unit is connected to the fourth center tap. As a result, the inputs can be decoupled from the outputs so that the electrical component connected to the outputs can be protected against the charging voltages during the charging process.

According to a further advantageous embodiment, the switching assembly comprises a first node point connecting the first switching unit to the third switching unit and the first output and a second node point connecting the second switching unit to the fourth switching unit and the second output.

It is advantageous when the sixth switching unit is arranged between the first node point and the first input and the seventh switching unit is arranged between the second node point and the second input. Thus, the energy storage system can be connected to the inputs as well as the outputs via the two node points.

According to a further embodiment, the first switching unit, the second switching unit, the third switching unit, and the fourth switching unit each comprise two semiconductor switching elements arranged so as to be connected to one another in an antiserial manner, wherein a first center tap is arranged between the semiconductor switching elements of the first switching unit, wherein a second center tap is arranged between the semiconductor switching elements of the second switching unit, wherein a third center tap is arranged between the semiconductor switching elements of the third switching unit, wherein a fourth center tap is arranged between the semiconductor switching elements of the fourth switching unit, wherein the sixth switching unit is connected to the first center tap and the third center tap, and the seventh switching unit is connected to the second center tap and the fourth center tap. It is advantageous that the inputs can be decoupled from the outputs so that the electrical component connected to the outputs can be protected against the charging voltages during the charging process.

According to a further embodiment, the first switching unit and the third switching unit each comprise a mechanical switching element, or the second switching unit and the fourth switching unit each comprise a mechanical switching element, or the second switching unit and the third switching unit each comprise a mechanical switching element. As a result, the advantages of the semiconductor switching elements can be combined with the advantages of the mechanical switching elements.

According to a further embodiment, the second switching unit comprises a single semiconductor switching element, which is configured in particular so as to block in the charging direction, and the fourth switching unit comprises a single semiconductor switching element, which is configured in particular so as to block in the charging direction, wherein a first fuse is arranged between the first pole terminal of the first energy storage unit and the first switching unit, wherein a second fuse is arranged between the second pole terminal of the second energy storage unit and the fourth switching unit. It is advantageous in this respect that the second and fourth switching units can be designed in a simplified manner. An interruption of the switching assembly in the decharging direction is enabled by the fuses.

Advantageously, the first fuse and/or the second fuse is configured as a relay or pyrotechnic switch. The fuse can thus be designed irreversibly or reversibly, depending on the application.

It is further advantageous when the fifth switching unit and/or the sixth switching unit and/or the seventh switching unit each comprise a single semiconductor switching element, which is configured in particular so as to block in the decharging direction. As a result, these switching units can be designed in a simplified manner. An additional fuse is not necessarily required in these cases, because these switching units must only be able to block in the decharging direction.

Alternatively, the fifth switching unit and/or the sixth switching unit and/or the seventh switching unit can each comprise two semiconductor switching elements arranged so as to be connected to one another in an antiserial manner. Thus, these switching units can optionally block in the charging direction and/or in the decharging direction.

Further alternatively, the fifth switching unit and/or the sixth switching unit and/or the seventh switching unit can comprise a mechanical switching element, in particular a relay or contactor. As a result, the advantages of the semiconductor switching elements can be combined with the advantages of the mechanical switching elements.

Furthermore, it is advantageous when one of the antiserially connected semiconductor switching elements is respectively configured so as to block in the charging direction and the other of the antiserially connected semiconductor switching elements is respectively configured so as to block in the decharging direction. The respective semiconductor switching elements can be activated in a targeted manner so that the energy storage system can, for example, decharge but not charge at one time.

Advantageously, the source terminals or the discharge terminals of the antiserially arranged semiconductor switching elements are connected to one another. The assembly can be selected as a function of the application of the switching assembly.

The core of the invention in the electrical energy storage system having at least two electrical energy storage units consists in that the electrical energy storage system comprises a switching assembly as previously described or according to any one of the claims aimed at the switching assembly.

The core of the invention in the use of a switching assembly as described above or according to any of the claims aimed at the switching assembly consists in that the switching assembly is used in an electrically driven vehicle or in a hybrid vehicle.

The background of the invention is that the vehicle can be charged using various DC voltage sources. Thus, the availability of charging stations for the vehicle is improved.

The vehicle can be configured as a land vehicle and/or an aquatic vehicle and/or an aircraft having an electric drive and optionally additionally an internal combustion engine as a drive. The vehicle can thus be configured as a purely electrically driven vehicle or a hybrid vehicle.

In particular, an electrical energy storage unit can be understood to mean an electrochemical battery cell and/or a battery module having at least one electrochemical battery cell and/or a battery pack having at least one battery module. For example, the electrical energy storage unit can be a lithium battery cell or a lithium battery module or a lithium battery pack. In particular, the electrical energy storage unit can be a lithium ion battery cell or a lithium ion battery module or a lithium ion battery pack. Furthermore, the battery cell can be of the type lithium polymer battery, nickel-metal hydride battery, lead-acid battery, lithium-air battery, or lithium-sulfur battery, or very generally a battery of any electrochemical composition.

### BRIEF DESCRIPTION OF THE DRAWINGS

The drawings show:

FIG. 1 a first exemplary embodiment of a switching assembly of an electrical energy storage system 1 according to the invention;

FIG. 2 a second exemplary embodiment of a switching assembly of an electrical energy storage system 11 according to the invention;

FIG. 3 a third exemplary embodiment of a switching assembly of an electrical energy storage system 21 according to the invention;

FIG. 4 a fourth exemplary embodiment of a switching assembly of an electrical energy storage system 31 according to the invention;

FIG. 5 a fifth exemplary embodiment of a switching assembly of an electrical energy storage system 41 according to the invention;

FIG. 6 a sixth exemplary embodiment of a switching assembly of an electrical energy storage system 51 according to the invention;

FIG. 7 a seventh exemplary embodiment of a switching assembly of an electrical energy storage system 61 according to the invention;

FIG. 8 an eighth exemplary embodiment of a switching assembly of an electrical energy storage system 71 according to the invention;

and

FIG. 9 a ninth exemplary embodiment of a switching assembly of an electrical energy storage system 81 according to the invention.

### DETAILED DESCRIPTION

In the following section, the invention is explained on the basis of exemplary embodiments, from which further inventive features can arise, to which the scope of the invention is however not limited. The exemplary embodiments of the invention are illustrated in the drawings.

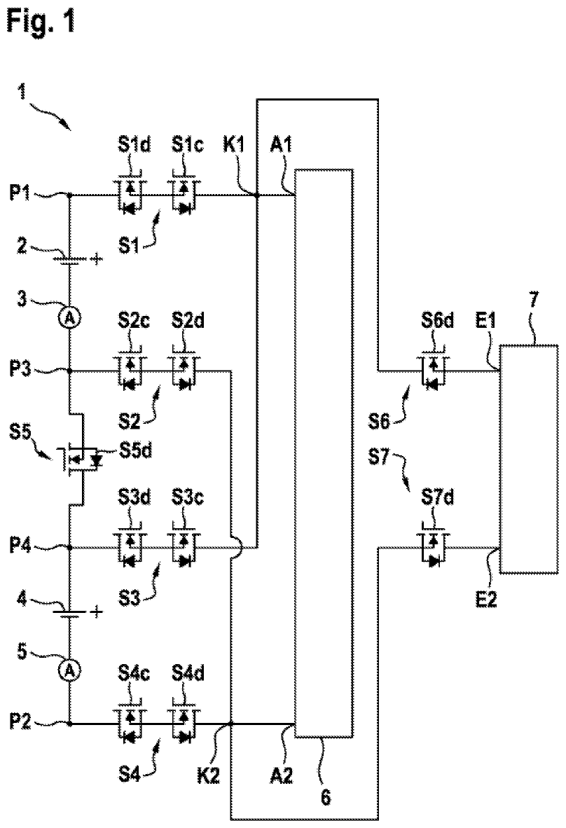

In FIG. 1, a first embodiment of the switching assembly for an energy storage system 1 according to the invention is shown.

The energy storage system 1 comprises a first energy storage unit 2 and a second energy storage unit 4, each comprising an energy storage cell. The respective energy storage unit (2, 4) can also comprise a plurality of energy storage cells in serial circuitry or a combination of energy storage cells in serial circuitry and parallel circuitry or a parallel circuitry of energy storage cells.

Each energy storage unit (2, 4) respectively comprises a first, in particular positive, pole terminal (P1, P4) and a second, in particular negative, pole terminal (P3, P2) and a current sensor 3.

The energy storage system 1 is electrically conductively connectable to a voltage source 7 by means of a first input E1 and a second input E2. A first switching unit S1 and a sixth switching unit S6 are arranged between the first input E1 and the first pole terminal P1 of the first energy storage unit 2. A first node point K1 is arranged between the first switching unit S1 and the sixth switching unit S6, wherein the first switching unit S1 is arranged between the first node point K1 and the first pole terminal P1 of the first energy storage unit 2, and the sixth switching unit S6 is arranged between the first node point K1 and the first input E1. A third switching unit S3 is arranged between the first node point K1 and the first pole terminal P4 of the second energy storage unit 4. The first node point K1 thus connects the first switching unit S1 to the third switching unit S3 and the sixth switching unit S6.

Here, “connected electrically conductively” is understood to mean able to be connected in an electrically conductive manner.

A second switching unit S2 and a seventh switching unit S7 are arranged between the second input E2 and the second pole terminal P3 of the first energy storage unit 2. A second node point K2 is arranged between the second switching unit S2 and the seventh switching unit S7, wherein the second switching unit S2 is arranged between the second node point K2 and the second pole terminal P3 of the first energy storage unit 2 and the seventh switching unit S7 is arranged between the second node point K2 and the second input E2. A fourth switching unit S4 is arranged between the second node point K2 and the second pole terminal P2 of the second energy storage unit 4. The second node point K2 thus connects the second switching unit S1 to the fourth switching unit S4 and the seventh switching unit S7.

The energy storage units (2, 4) can be serially connected by means of a fifth switching unit S5. For this purpose, the fifth switching unit S5 is arranged between the second pole terminal P3 of the first energy storage unit 2 and the first pole terminal P4 of the second energy storage unit 4. As a result, the second pole terminal P3 of the first energy storage unit 2 and the first pole terminal P4 of the second energy storage unit 4 can be electrically conductively connected.

To connect the energy storage units (2, 4) in series, the fifth switching unit S5 is closed and the second switching unit S2 and the third switching unit S3 are opened.

To connect the energy storage units (2, 4) in parallel, the fifth switching unit S5 is opened and the second switching unit S2 and the third switching unit S3 are closed.

According to the first exemplary embodiment, the respective switching units (S1, S2, S3, S4, S5, S6, S7) comprise at least one semiconductor switching element, in particular a transistor, in particular a power transistor, in particular a MOSFET or an IGBT.

The first switching unit S1, the second switching unit S2, the third switching unit S3, and the fourth switching unit S4 each comprise two semiconductor switching elements arranged so as to be connected to one another in an antiserial manner. One semiconductor switching element of each of these switching units (S1, S2, S3, S4) functions as a decharging switch (S1d, S2d, S3d, S4d) and the other semiconductor switching element functions as a charging switch (S1c, S2c, S3c, S4c). The decharging switches (S1d, S2d, S3d, S4d) are configured so as to interrupt the current flow in the decharging direction, and the charging switches (S1c, S2c, S3c, S4c) are configured so as to interrupt the current flow in the charging direction.

The two semiconductor switching elements are arranged adjacent to one another such that the source terminals of the two semiconductor switching elements are connected to one another (common-source) or that the discharge terminals of the two semiconductor switching elements are connected to one another (common-drain).

The decharging direction is understood to mean the direction of the current flow in the switching assembly when the electrical energy storage system is decharged. The charging direction is understood to mean the direction of the current flow in the switching assembly when the electrical energy storage system is charged.

The fifth switching unit S5, the sixth switching unit S6, and the seventh switching unit S7 each comprise only one semiconductor switching element. The respective semiconductor switching element of these switching units functions as a decharging switch (S5d, S6d, S7).

According to an exemplary embodiment not shown in the figures, the fifth switching unit S5 and/or the sixth switching unit S6 and/or the seventh switching unit S7 can each also comprise two semiconductor switching elements arranged so as to be connected to one another in an antiserial manner. Alternatively, the fifth switching unit S5 and/or the sixth switching unit S6 and/or the seventh switching unit S7 can comprise a mechanical switching element, in particular a contactor or a relay.

The energy storage system 1 is electrically conductively connectable to an electrical component 6 powered from the energy storage system 1 by means of a first output A1 and a second output A2. The first output A1 is connected to the first node point K1 and the second output A2 is connected to the second node point K2.

For example, the switching assembly according to the invention for an energy storage system 1 can be used for an electric motor of a vehicle. For this purpose, the outputs (A1, A2) of the energy storage system 1 are connected to a vehicle on-board network.

The described use of a switching assembly for an energy storage system 1 is also possible in energy technology, for example in wind power technology or solar power technology or hydro-power technology, or for buffer storage.

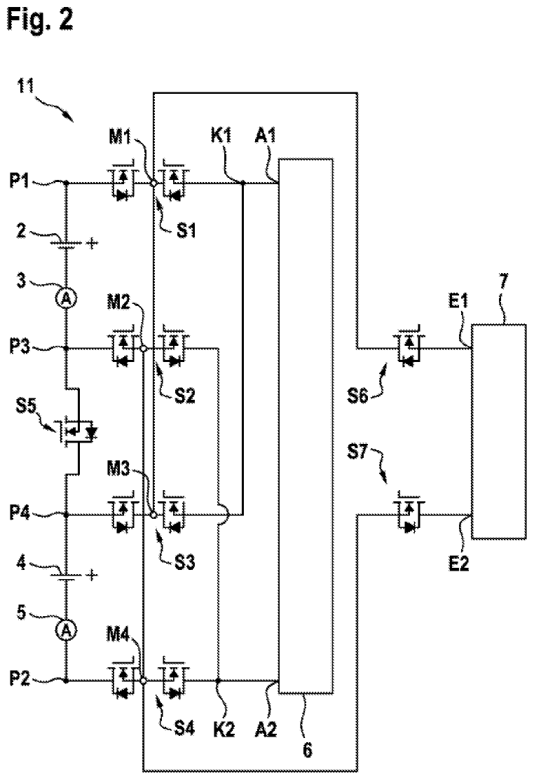

In FIG. 2, a second embodiment of the switching assembly for an energy storage system 11 according to the invention is shown.

In addition to the first embodiment, the second embodiment of the switching assembly according to the invention comprises a first center tap M1, a second center tap M2, a third center tap M3, and a fourth center tap M4.

The first center tap M1 is arranged between the first charging switch and the first decharging switch of the first switching unit S1. The second center tap M2 is arranged between the second charging switch and the second decharging switch of the second switching unit S2. The third center tap M3 is arranged between the third charging switch and the third decharging switch of the third switching unit S3. The fourth center tap M4 is arranged between the fourth charging switch and the fourth decharging switch of the fourth switching unit S4.

The first pole terminal P4 of the second energy storage unit 4 can be connected to the first pole terminal P1 of the first energy storage unit 2 and the first input E1 by means of the third center tap M3 and the first center tap M1 and the sixth switching unit S6.

The second pole terminal P3 of the first energy storage unit 2 can be connected to the second pole terminal P2 of the second energy storage unit 4 and the second input E2 by means of the second center tap M2 and the fourth center tap M4 and the seventh switching unit S7

The respective decharging switch (S1d, S2d, S3d, S4d) is arranged between the respective pole terminal (P1, P2, P3, P4) and the respective center tap (M1, M2, M3, M4) and the respective charging switch (S1c, S2c, S3c, S4c) is arranged between the respective center tap (M1, M2, M3, M4) and the respective input (E1, E2).

By contrast to the first exemplary embodiment, the first node point K1 is not directly connected to the sixth switching unit S6 and the second node point K2 is not directly connected to the seventh switching unit S7.

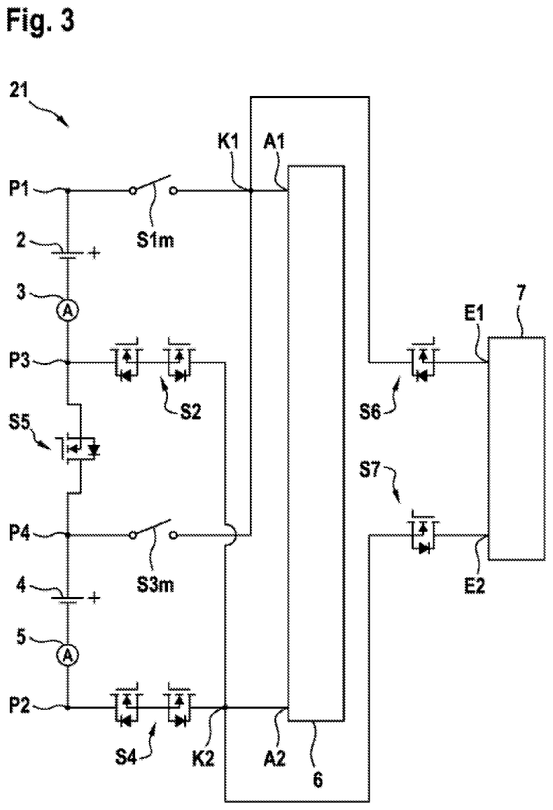

In FIG. 3, a third embodiment of the switching assembly for an energy storage system 21 according to the invention is shown.

The third embodiment of the switching assembly differs from the first embodiment in that, instead of the first switching unit S1, a first mechanical switching element S1m is arranged between the first pole terminal P1 of the first energy storage unit 2 and the first node point K1. Instead of the third switching unit S3, a third mechanical switching element S3m is arranged between the first pole terminal P4 of the second energy storage unit 4 and the first node point K1. The respective mechanical switching element (S1m, S3m) can be configured as a contactor or relay.

According to an alternative exemplary embodiment not shown in the figures, a second mechanical switching element instead of the second switching unit S2, and a fourth mechanical switching element instead of the fourth switching unit S4, can be arranged in the switching assembly, while the first switching unit S1 and the third switching unit S3 each comprise two semiconductor switching elements arranged so as to be connected to one another in an antiserial manner.

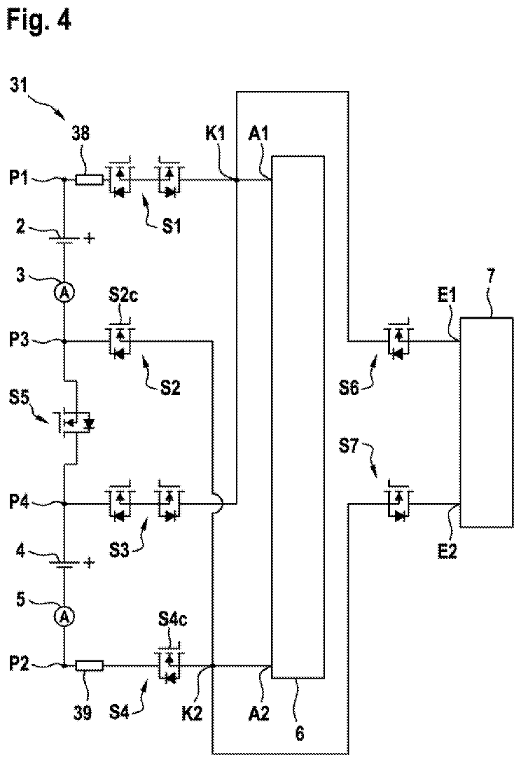

In FIG. 4, a fourth embodiment of the switching assembly for an electrical energy storage system 31 according to the invention is shown.

The fourth embodiment differs from the first embodiment in that the second switching unit S2 only comprises a second charging switch S2c and no second decharging switch S2d, and the fourth switching unit S4 comprises only a fourth charging switch S4c and no fourth decharging switch S4d. The switching assembly comprises a first fuse 38 and a second fuse 39. The respective fuse (38, 39) can be configured as a pyrotechnic switching element, for example.

The first fuse 38 is arranged between the first pole terminal P1 of the first energy storage unit 2 and the first switching unit S1. The first fuse 38 is configured so as to interrupt a decharging current to the first output A1.

The second fuse 30 is arranged between the second pole terminal P2 of the second energy storage unit 4 and the fourth switching unit S4. The second fuse 39 is configured so as to interrupt a decharging current to the second output A2.

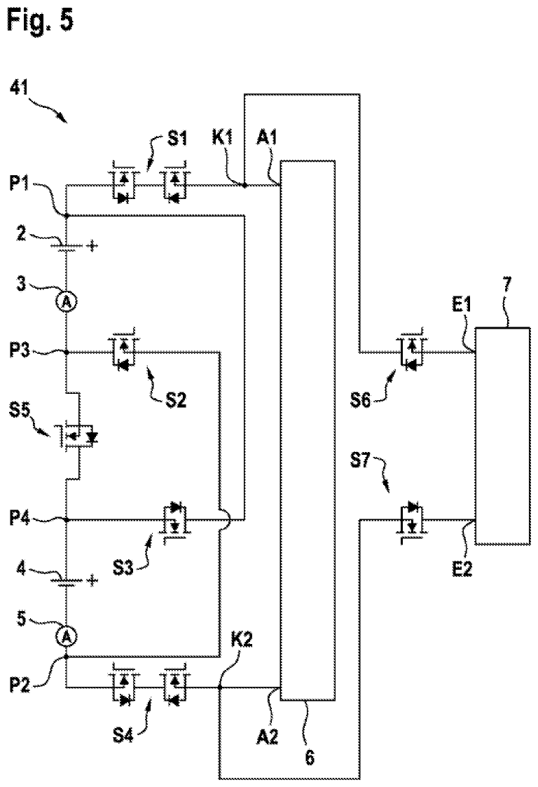

FIG. 5 shows a fifth exemplary embodiment of the switching assembly for an electrical energy storage system 41 according to the invention.

The fifth exemplary embodiment differs from the previous exemplary embodiments in that the first pole terminal P1 of the first energy storage unit 2 can be connected to the first pole terminal P4 of the second energy storage unit 4 by means of the third switching unit S3 and that the second pole terminal P3 of the first energy storage unit 2 can be connected to the second pole terminal P2 of the second energy storage unit 4 by means of the second switching unit S2.

The first node point K1 connects the first switching unit S1 to the first output A1 and the first input E1.

The second node point K2 connects the fourth switching unit S4 to the second output A2 and the second input E2.

In the fifth exemplary embodiment of the switching assembly, the first switching unit S1 and the fourth switching unit S4 each comprise two semiconductor switching elements. The respective two semiconductor switching elements are arranged such that the respective discharge terminals are connected to one another.

The second switching unit S2, the third switching unit S3, the fifth switching unit S5, the sixth switching unit S6, and the seventh switching unit S7 each comprise a single semiconductor switching element.

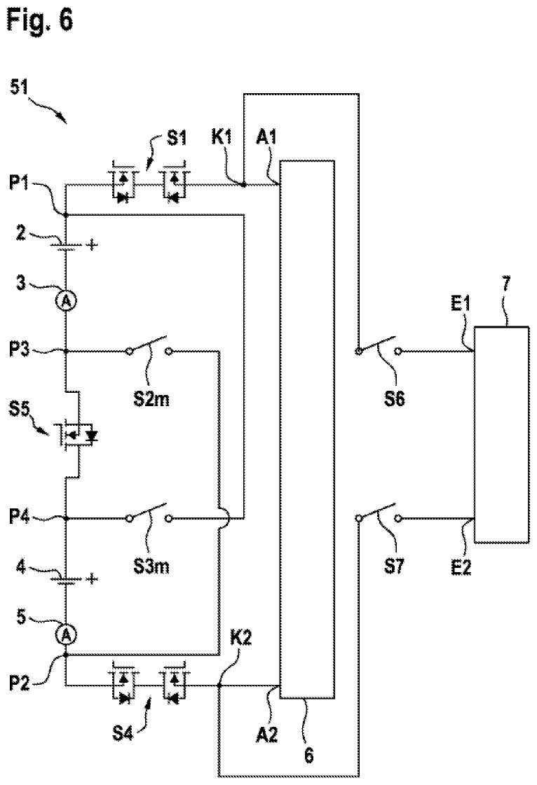

FIG. 6 shows a sixth exemplary embodiment of the switching assembly for an electrical energy storage system 51 according to the invention.

The sixth exemplary embodiment differs from the fifth exemplary embodiment in that the second switching unit S2, the third switching unit S3, the fifth switching unit S5, the sixth switching unit S6, and the seventh switching unit S7 each comprise a mechanical switching element.

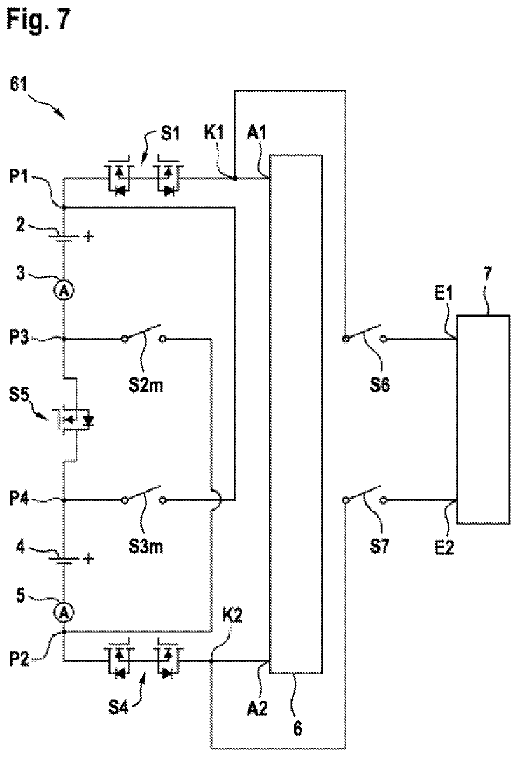

FIG. 7 shows a seventh exemplary embodiment of the switching assembly for an electrical energy storage system 61 according to the invention.

The seventh exemplary embodiment differs from the sixth exemplary embodiment in that the antiserially arranged semiconductor switching elements are arranged such that the respective source terminals of the two semiconductor switching elements are connected to one another.

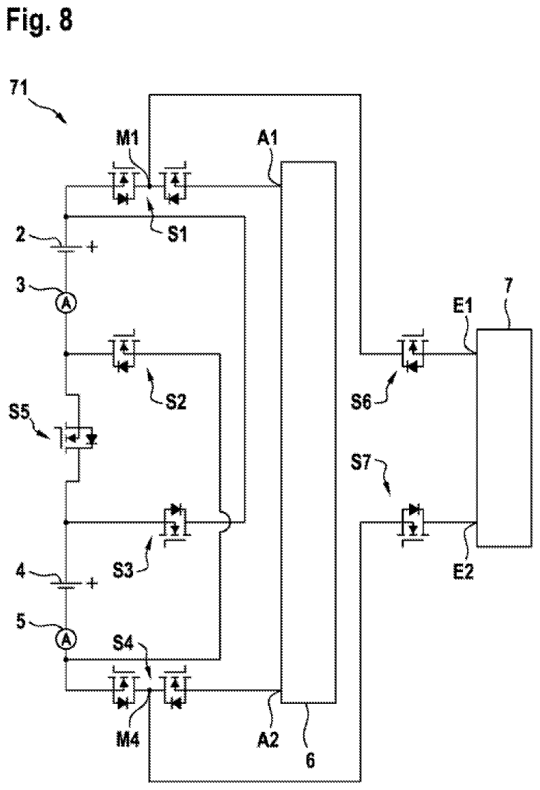

FIG. 8 shows an eighth exemplary embodiment of the switching assembly for an electrical energy storage system 71 according to the invention.

The eighth exemplary embodiment differs from the fifth exemplary embodiment in that a first center tap M1 is arranged between the semiconductor switching elements of the first switching unit S1, which connects the first input E1 to the first switching unit S1. The first output A1 is directly connected to the first switching unit S1.

In addition, a fourth center tap M4 is arranged between the semiconductor switching elements of the fourth switching unit S4, which connects the second input E2 to the fourth switching unit S4. The second output A2 is directly connected to the fourth switching unit S4.

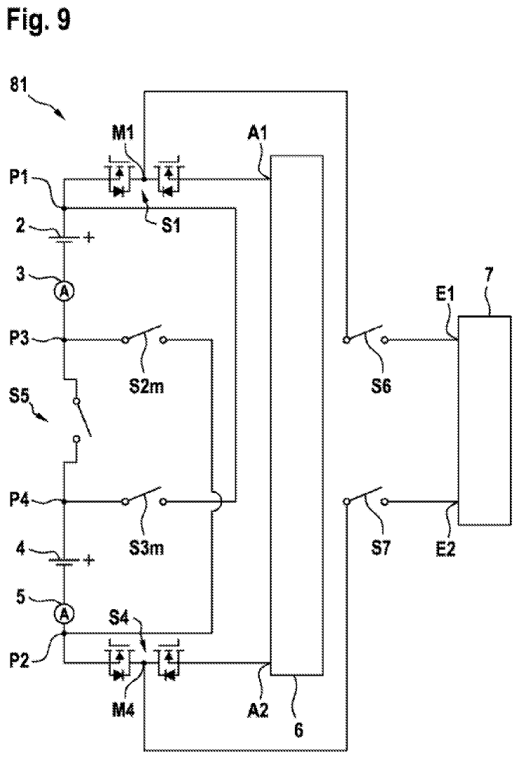

FIG. 9 shows a ninth exemplary embodiment of the switching assembly for an electrical energy storage system 81 according to the invention.

The ninth exemplary embodiment differs from the eighth exemplary embodiment in that the second switching unit S2, the third switching unit S3, the fifth switching unit S5, the sixth switching unit S6, and the seventh switching unit S7 each comprise a respective mechanical switching element.

1. A switching assembly for an electrical energy storage system (1, 11, 21, 31, 41, 51, 61, 71, 81) having a first energy storage unit (2) and a second energy storage unit (4), each having a first pole terminal (P1, P4) and a second pole terminal (P3, P2), the switching assembly comprising:
at least a first output (A1) and a second output (A2) for electrically conductive connection to at least one electrical component (6),
a first switching unit (S1) arranged between the first pole terminal (P1) of the first energy storage unit (2) and the first output (A1),
a second switching unit (S2) arranged between the second pole terminal (P3) of the first energy storage unit (2) and the second output (A2),
a third switching unit (S3) arranged between the first pole terminal (P4) of the second energy storage unit (4) and the first output (A1),
a fourth switching unit (S4) arranged between the second pole terminal (P2) of the second energy storage unit (4) and the second output (A2), and
a fifth switching unit (S5) arranged between the second pole terminal (P3) of the first energy storage unit (2) and the first pole terminal (P4) of the second energy storage unit (4),
wherein the first switching unit (S1) is connected to the third switching unit (S3),
wherein the second switching unit (S2) is connected to the fourth switching unit (S4), and
wherein at least the first switching unit (S1) and the third switching unit (S3) and/or the second switching unit (S2) and the fourth switching unit (S4) or the first switching unit (S1) and the fourth switching unit (S4) comprise two semiconductor switching elements arranged so as to be connected to one another in an antiserial manner.

2. The switching assembly according to claim 1,
wherein
the switching assembly comprises at least a first input (E1) and a second input (E2) for electrically conductive connection to a voltage source (7),
wherein the first input (E1) can be connected to the first switching unit (S1) and the third switching unit (S3), and
wherein the second input (E2) can be connected to the second switching unit (S2) and the fourth switching unit (S4).

3. The switching assembly according to claim 1,
wherein
the first pole terminal (P1) of the first electrical energy storage unit (2) can be connected by means of the third switching unit (S3) to the first pole terminal (P4) of the second electrical energy storage unit (4), and the second pole terminal (P3) of the first electrical energy storage unit (2) can be connected by means of the second switching unit (S2) to the second pole terminal (P2) of the second electrical energy storage unit (4).

4. The switching assembly according to claim 3,
wherein
the second switching unit (S2) comprises a single semiconductor switching element, which is configured to block in the charging direction, and the third switching unit (S3) comprises a single semiconductor switching element, which is configured to block in the charging direction.

5. The switching assembly according to claim 3,
wherein
the first switching unit (S1) and the fourth switching unit (S4) each comprise two semiconductor switching elements arranged so as to be connected to one another in an antiserial manner,
wherein a first center tap (M1) is arranged between the semiconductor switching elements of the first switching unit (S1),
wherein a fourth center tap (M4) is arranged between the semiconductor switching elements of the fourth switching unit (S4), and
wherein the sixth switching unit (S6) is connected to the first center tap (M1) and the seventh switching unit (S7) is connected to the fourth center tap (M4).

6. The switching assembly according to claim 1,
wherein
the switching assembly comprises a first node point (K1) connecting the first switching unit (S1) to the third switching unit (S3) and the first output (A1) and a second node point (K2) connecting the second switching unit (S2) to the fourth switching unit (S4) and the second output (A2).

7. The switching assembly according to claim 6,
wherein
the sixth switching unit (S6) is arranged between the first node point (K1) and the first input (E1) and the seventh switching unit (S7) is arranged between the second node point (K2) and the second input (E2).

8. The switching assembly according to claim 6 or 7,
wherein
the first switching unit (S1), the second switching unit (S2), the third switching unit (S3), and the fourth switching unit (S4) each comprise two semiconductor switching elements arranged so as to be connected to one another in an antiserial manner,
wherein a first center tap (M1) is arranged between the semiconductor switching elements of the first switching unit (S1),
wherein a second center tap (M2) is arranged between the semiconductor switching elements of the second switching unit (S2),
wherein a third center tap (M3) is arranged between the semiconductor switching elements of the third switching unit (S3),
wherein a fourth center tap (M4) is arranged between the semiconductor switching elements of the fourth switching unit (S4), and
wherein the sixth switching unit (S6) is connected to the first center tap (M1) and the third center tap (M3), and the seventh switching unit (S7) is connected to the second center tap (M2) and the fourth center tap (M4).

9. The switching assembly according to claim 6,
wherein
the second switching unit (S2) comprises a single semiconductor switching element, which is configured to block in the charging direction, and the fourth switching unit (S4) comprises a single semiconductor switching element, which is configured to block in the charging direction,
wherein a first fuse (38) is arranged between the first pole terminal (P1) of the first energy storage unit (2) and the first switching unit (S1), and
wherein a second fuse (39) is arranged between the second pole terminal (P2) of the second energy storage unit (4) and the fourth switching unit (S4).

10. The switching assembly according to claim 1,
wherein
the first switching unit (S1) and the third switching unit (S3) each comprise a mechanical switching element,
or that the second switching unit (S2) and the fourth switching unit (S4) each comprise a mechanical switching element,
or that the second switching unit (S2) and the third switching unit (S3) each comprise a mechanical switching element.

11. The switching assembly according to claim 1,
wherein
the fifth switching unit (S5) and/or the sixth switching unit (S6) and/or the seventh switching unit (S7) each comprise a single semiconductor switching element, which is configured to block in the decharging direction, or two semiconductor switching elements arranged so as to be connected to one another in an antiserial manner, or a mechanical switching element.

12. The switching assembly according to claim 1,
wherein
one of the antiserially connected semiconductor switching elements is respectively configured so as to block in the charging direction and the other of the antiserially connected semiconductor switching elements is respectively configured so as to block in the decharging direction,
and/or that the source terminals or the discharge terminals of the antiserially arranged semiconductor switching elements are connected to one another.

13. An electrical energy storage system (1, 11, 21, 31) having at least two electrical energy storage units (2, 4),
wherein
the electrical energy storage system (100) comprises a switching assembly according to claim 1.

14. A use of a switching assembly according to claim 1 in an electrically driven vehicle or in a hybrid vehicle.
